(19) United States
(12) Patent Application Publication
(10) Pub. No.: US 2015/0282267 A1
(43) Pub. Date: Oct. 1, 2015

(54) LIGHT-EMITTING MODULE AND LIGHT SOURCE

(71) Applicant: Kabushiki Kaisha Toshiba, Tokyo (JP)

(72) Inventor: Norikazu Nagasawa, Ome (JP)

(21) Appl. No.: 14/477,622

(22) Filed: Sep. 4, 2014

Related U.S. Application Data
(60) Provisional application No. 61/970,229, filed on Mar. 25, 2014.

(51) Int. Cl. H05B 33/08

(52) U.S. Cl. CPC H05B 33/0845

(57) ABSTRACT

According to one embodiment, a light-emitting module includes a first light-emitting element in which a luminance for a first current I1 is within a first range L1 including a first luminance, and a second light-emitting element in which a luminance for the first current I1 is within a third range, and a luminance for a second current I2 which is higher than the first current I1 is within a second range L2 including a second luminance which is higher than the first luminance, and a luminance of a third range is higher than a luminance of the first range. A first light-emitting element and a second light-emitting element are within one package.

### CROSS-REFERENCE TO RELATED APPLICATIONS

This application claims the benefit of U.S. Provisional Application No. 61/970,229, filed Mar. 25, 2014, the entire contents of which are incorporated herein by reference.

### FIELD

Embodiments described herein relate generally to a light source.

### BACKGROUND

Various types of light sources incorporating a light-emitting diode (hereinafter, referred to as an LED) have been practically used. As an example, an LED is employed for the backlight of a liquid crystal display panel. A light source is provided at an end or a plurality of ends of the display panel. The light from the light source is guided to the whole area of the back surface of the display panel by means of a light guide plate. Thus, a surface light source is structured.

Even for a liquid crystal display panel whose screen size is 6 to 7 inches, approximately twenty LEDs are used. LEDs vary in terms of luminance and characteristics of color, etc., depending on the manufacturing error. If a backlight is formed by using LEDs which are different in characteristics, the luminance or color, etc., of the display screen may become non-uniform. To prevent this non-uniformity, LEDs are driven with a constant current, and the luminance and color of the LEDs are measured one by one. The LEDs are categorized into some groups in such a way that LEDs having substantially the same characteristics belong to the same group. When the backlight is formed by using only the LEDs in the same group, the backlight can be free from non-uniformity in characteristics.

However, the variation in characteristics of LEDs depends on the drive current. Therefore, even if the characteristics are substantially the same in a state where the LEDs are driven with a constant current, the change in drive current may cause non-uniformity in characteristics.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 shows an exemplary liquid crystal display panel using a light source device according to a first embodiment.

FIG. 2 shows an exemplary LED array of a backlight of an edge light type of the liquid crystal display panel.

FIG. 3 shows an exemplary principle of the backlight of the edge light type.

FIG. 4A shows an exemplary drive circuit of the backlight.

FIG. 4B shows an example of the LED array of the backlight.

FIG. 4C shows another example of the LED array of the backlight.

FIG. 5A shows an example of current and luminance characteristics of first and second LED groups included in an LED module according to the embodiment.

FIG. 5B shows another example of the current and luminance characteristics of the first and second LED groups included in the LED module according to the embodiment.

FIG. 6A shows an exemplary drive circuit of a backlight of a liquid crystal display panel according to a second embodiment.

FIG. 6B shows an example of an LED array of the backlight according to the second embodiment.

FIG. 6C shows another example of the LED array of the backlight according to the second embodiment.

### DETAILED DESCRIPTION

Various embodiments will be described hereinafter with reference to the accompanying drawings.

In general, according to one embodiment, a light-emitting module includes: a first light-emitting element in which a luminance for a first current I1 is within a first range L1 including a first luminance; and a second light-emitting element in which a luminance for the first current I1 is within a third range, and a luminance for a second current I2 which is higher than the first current I1 is within a second range L2 including a second luminance which is higher than the first luminance, and a luminance of the third range is higher than a luminance of the first range. The first light-emitting element and the second light-emitting element are within one package.

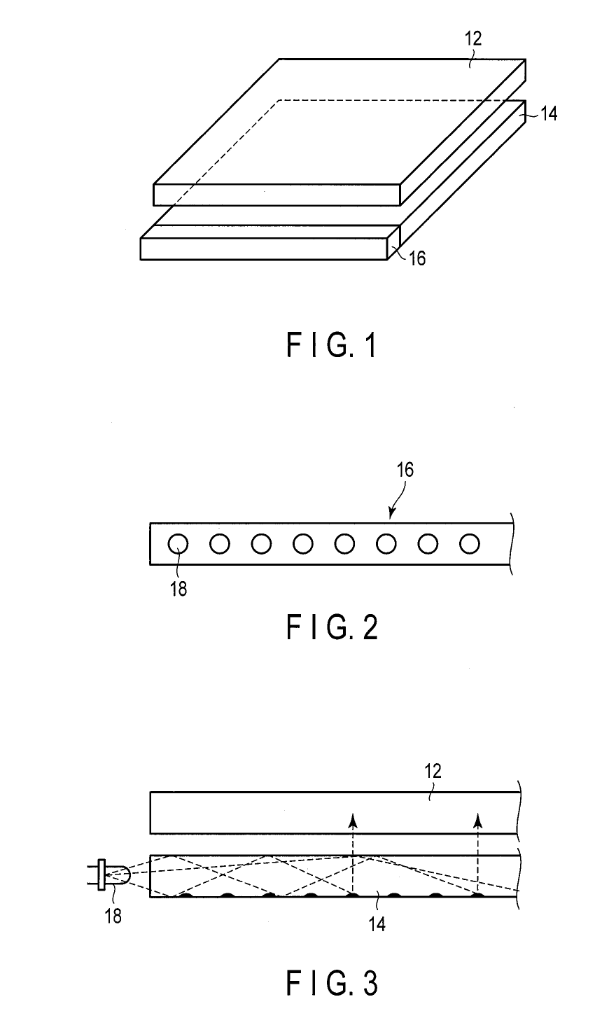

FIG. 1 shows an exemplary liquid crystal display panel using a light source device according to a first embodiment. A light guide plate 14 is provided under a liquid crystal display panel 12. The size of the light guide plate 14 is substantially same as the size of the liquid crystal display panel 12. The liquid crystal display panel 12 is composed of a polarization filter (perpendicular polarization), a glass substrate (individual electrode), a liquid crystal layer, a glass substrate (common electrode) and a polarization filter (horizontal polarization) although this structure is not illustrated in the figure. The lower surface of the light guide plate 14 is a light reflection surface, and the upper surface is a light emission surface. At an end of the light guide plate 14, an LED light source 16 is provided. As shown in FIG. 2, the LED light source 16 is composed of a plurality of LED modules 18 arranged in line on the substrate provided along the end of the light guide plate 14. As shown in FIG. 3, the light from the LED light source 16 enters the light incident end which is the end of the light guide plate 14, and the light is propagated to the whole surface under the liquid crystal display panel 12 while the light is reflected inside the light guide plate 14. The light guide plate 14 is produced by means of a serigraph system, a molding system or an adhesion dot system, etc. In the serigraph system, reflection dots are printed on the lower surface of an acrylic board by using white ink. In the molding system, asperity is formed on the lower surface of an acrylic board by a stamper, etc. In the adhesion dot system, the lower surface of an acrylic board is attached to a reflection board by using a dot type of adhesive. The light propagated thorough repeated reflections inside the light guide plate 14 scatters in reflection dots, and enters the liquid crystal display panel 12 via the light emission surface which is the upper surface of the light guide plate 14. The light is uniformly spread to the whole light guide plate 14 by making the areas or density of the reflection dots smaller as the reflection dots are closer to the LED light source 16, and making the areas or density larger as the reflection dots are away from the LED light source 16.

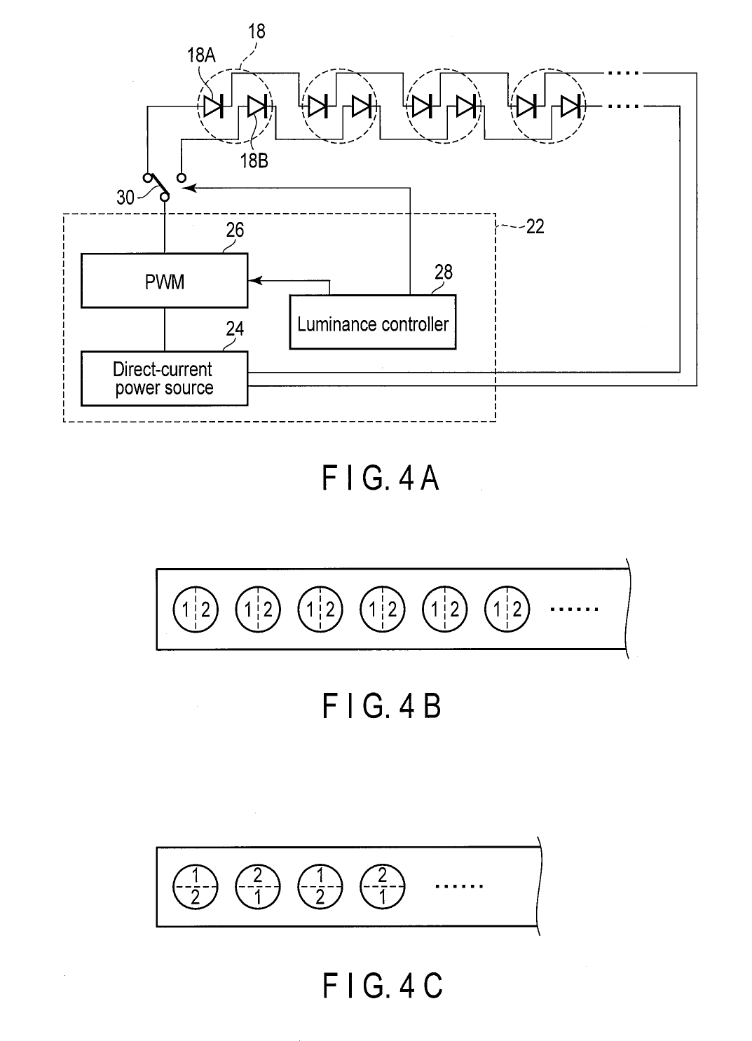

Each LED module 18 is a so-called multi-chip module, which includes a plurality of LEDs within one package. As shown in FIG. 4A, each LED module 18 is composed of a plurality of LEDs which have different characteristics from each other. Here, each LED module 18 is composed of two LEDs 18A and 18B. As mentioned above, LEDs cannot avoid the variety in luminance or color, etc. Even at the same drive current, the luminance differs. Further, even if the luminance of LEDs is within the allowable range at a drive current, the change in the drive current may cause the luminance to be outside the allowable range. The drive current at which the luminance is within the allowable range depends on the LED. Therefore, in the manufacturing process, the luminance is measured, and all LEDs are categorized into a plurality of groups in such a way that each group includes LEDs having substantially the same luminance characteristics. The maximum number of groups is not limited. However, here, the LEDs are categorized into two groups which are a high-luminance group and a low-luminance group for convenience sake.

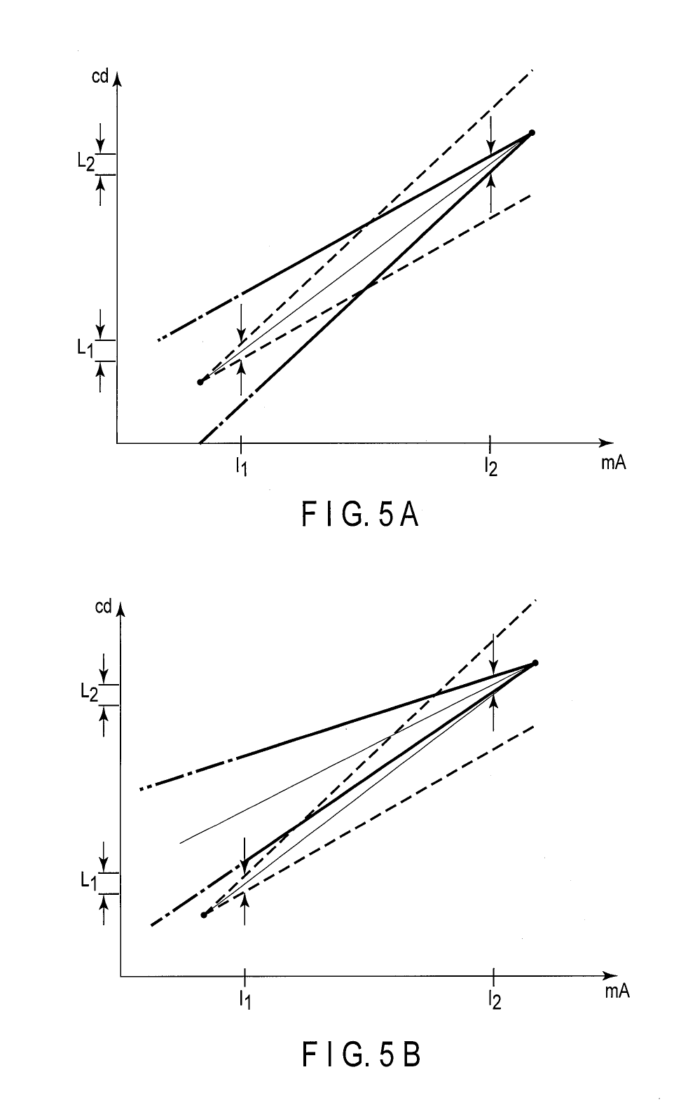

In the LEDs of the high-luminance group, as shown by the solid lines in FIG. 5A, when the drive current is high (I2), substantially there is no difference in luminance (if any, within the allowable range L2), and when the drive current is low, the difference in luminance stands out and goes outside the allowable range L1. For example, at the high current I2, each LED of the high-luminance group emits light with approximately the target luminance (for example, within 5% higher or lower than the target luminance). On the other hand, at the low current I1, each LED of the high-luminance group may emit light with the luminance ranging in 30% higher or lower than the target luminance. In the luminance of each LED of the high-luminance group, the range of distribution at the low current I1 is wider than the range of distribution at the high current I2.

In the LEDs of the low-luminance group, as shown by the dashed lines of FIG. 5A, when the drive current is low (I1), substantially there is no difference in luminance (if any, within the allowable range L1), and when the drive current is high, the difference in luminance stands out and goes outside the allowable range L2. For example, at the low current I1, each LED of the low-luminance group emits light with approximately the target luminance (for example, within 5% higher or lower than the target luminance). On the other hand, at the high current I2, each LED of the low-luminance group may emit light with the luminance ranging in 30% higher or lower than the target luminance. In the luminance of each LED of the low-luminance group, the range of distribution at the high current I2 is wider than the range of distribution at the low current I1. For example, the first LED 18A is selected from the LEDs of the high-luminance group, and the second LED 18B is selected from the LEDs of the low-luminance group.

In the example of FIG. 5A, the luminance distribution range of the LEDs of the high-luminance group when the drive current is low (I1) includes the luminance distribution range L1 at the low current (I1) of the LEDs of the low-luminance group. Similarly, the luminance distribution range of the LEDs of the low-luminance group when the drive current is high (I2) includes the luminance distribution range L2 at the high current (I2) of the LEDs of the high-luminance group. However, this relationship is not essential. As shown in FIG. 5B, the luminance distribution range of the LEDs of the low-luminance group when the drive current is high (I2) includes the luminance distribution range L2 at the high current (I2) of the LEDs of the high-luminance group, but the luminance distribution range of the LEDs of the high-luminance group when the drive current is low (I1) may not include the luminance distribution range L1 at the low current (I1) of the LEDs of the low-luminance group. In sum, as described later, since the LEDs of the high-luminance group are not used with low luminance, when the drive current is decreased, the luminance may not be reduced to the predetermined value. Similarly, although not shown in the figure, since the LEDs of the low-luminance group are not used with high luminance, when the drive current is increased, the luminance may not be increased to the predetermined value. Therefore, the luminance distribution range of the LEDs of the low-luminance group when the drive current is high (I2) may not include the luminance distribution range L2 at the high current (I2) of the LEDs of the high-luminance group.

In this embodiment, the luminance of each LED is measured at the low current I1 and the high current I2. The difference between the measured luminance and the target luminance is investigated. The classification of the LED into the high-luminance group or the low-luminance group is determined based on which one of the difference at the low current I1 and the difference at the high current I2 is larger. As shown by the dashed lines of FIG. 5A, when the difference at the low current I1 is smaller than the difference at the high current I2, the LED is categorized into the low-luminance group. As shown by the solid lines of FIG. 5A, when the difference at the low current I1 is larger than the difference at the high current I2, the LED is categorized into the high-luminance group.

FIG. 4B shows an example of an array of the LED modules 18 on the substrate which is not shown in the figure. Inside each LED module 18, the first and second LEDs are arranged on the left and right (within a row). The first LEDs 18A and the second LEDs 18B are arranged on the left and right (within a row) in such a way that each first LED 18A alternates with each second LED 18B, and the second LED 18B of one LED module is adjacent to the first LED 18A of the LED module to its right. The LED modules 18 are arranged at intervals as shown in FIG. 2. Since the light from each LED diffuses to a certain extent, even if the LED modules 18 are dispersed, it is possible to equally irradiate the light incident surface of the light guide plate 14 as long as the LEDs are distant from the light incident surface.

FIG. 4C shows another example of the array of the LED modules 18. Inside each LED module 18, the first and second LEDs are arranged on the upper and lower sides (within a column). In each of the LED modules provided at the positions of odd numbers, the first LED is arranged on the upper side, and the second LED is arranged on the lower side. In each of the LED modules provided at the positions of even numbers, the first LED is arranged on the lower side, and the second LED is arranged on the upper side. In this array, similarly, the first LED 18A and the second LED 18B of one LED module are adjacent to the second LED 18B and the first LED 18A of the LED module to its right. Thus, each first LED 18A alternates with each second LED 18B.

FIG. 4A shows an example of a circuit diagram of the light source device 16. In the array of the LED modules 18 arranged as shown in FIG. 4B or FIG. 4C, the first LEDs 18A are connected in series, and the second LEDs 18B are also connected in series. In other words, the first LED 18A and the second LED 18B inside one package are not electrically connected. The cathode of the LED at an end of the series-connected array of the first LEDs 18A and the cathode of the LED at an end of the series-connected array of the second LEDs 18B are connected to the negative terminal of a direct-current power source 24 within a drive circuit 22. The anode of the LED at the other end of the series-connected array of the first LEDs 18A and the anode of the LED at the other end of the series-connected array of the second LEDs 18B are connected to a pulse width modulator 26 within the drive circuit 22 via a selector 30. The pulse width modulator 26 is connected to the positive terminal of the direct-current power source 24. The pulse width modulator 26 adjusts the drive current by modulating the pulse width of the drive current supplied from the direct-current power source 24. In accordance with the luminance of the liquid crystal display panel set from the operational menu, etc., a luminance controller 28 switches the selector 30 and controls the pulse width (duty ratio) of the pulse width modulator 26. The selector 30 selects one of the series-connected array of the first LEDs 18A and the series-connected array of the second LEDs 18B in accordance with the output of the luminance controller 28. The first LED 18A has the current and luminance characteristics shown by the solid lines of FIG. 5A and FIG. 5B. The second LED 18B has the current and luminance characteristics shown by the dashed lines of FIG. 5A and FIG. 5B. Therefore, the luminance controller 28 controls the selector 30 in such a way that the selector 30 selects the series-connected array of the first LEDs 18A when the luminance setting of the liquid crystal display panel 12 is high luminance, and the selector 30 selects the series-connected array of the second LEDs 18B when low luminance.

Thus, the second LEDs 18B used in the case of low luminance are free from non-uniformity in luminance when the luminance is low as shown by the dashed lines of FIG. 5A and FIG. 5B, and the first LEDs 18A used in the case of high luminance are free from non-uniformity when the luminance is high as shown by the solid lines of FIG. 5A and FIG. 5B. Therefore, by selecting the first or second LED for use in accordance with the luminance setting, it is possible to realize a light source device which is free from non-uniformity in luminance.

In general, in terms of energy saving, there is demand for an LED which emits light with high luminance at a low current. The luminance of an LED can be controlled by adjusting the duty ratio of the drive current. However, the minimum value of the duty ratio which can be set is determined. Thus, the duty ratio of the drive current cannot be decreased to the minimum value or lower, and the controllable luminance has a lower limit. Therefore, in the case of use in a dark environment, etc., sometimes the display screen is too luminous to be seen. However, according to this embodiment, it is possible to emit light with appropriate luminance in any kind of surrounding brightness by selectively using the first LEDs 18A which evenly emit light with high luminance when the drive current is high and the second LEDs 18B which evenly emit light with low luminance when the drive current is low.

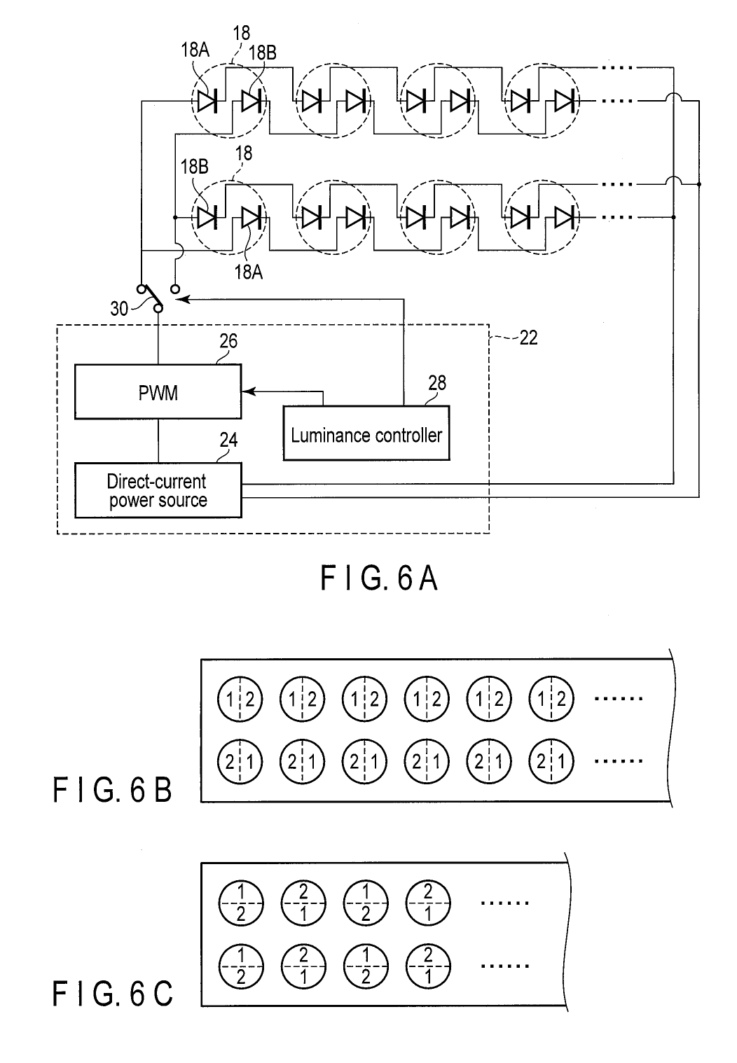

Next, a second embodiment is explained. The first embodiment relates to the case where the LED modules are arranged in a line. In the second embodiment, the case where LED modules are arranged in a plurality of lines is explained. FIG. 6A shows an exemplary drive circuit of a backlight of a liquid crystal display panel of the second embodiment. FIG. 6B shows an example of an LED array of the backlight of the second embodiment.

Here, this specification explains the case where LED modules are arranged in two lines. The array of LED modules 18 in the first line is the same as the first embodiment. First LEDs 18A and second LEDs 18B are arranged on the left and right (within a row) in such a way that each first LED 18A alternates with each second LED 18B, and the second LED 18B of one LED module is adjacent to the first LED 18A of the LED module to its right. The array of the LED modules 18 in the second line is opposite to the first line. In the second line, the first LEDs 18A and the second LEDs 18B are arranged on the right and left (within a row) in such a way that each first LED 18A alternates with each second LED 18B, and the first LED 18A of one LED module is adjacent to the second LED 18B of the LED module to its right. Therefore, on the upper and lower sides (within a column), similarly, the first LED 18A alternates with the second LED 18B. Thus, in the LED modules which are adjacent to each other on the upper and lower sides (within a column) and the right and left sides (within a row), each first LED 18A and each second LED 18B are alternately arranged.

FIG. 6C shows another example of the array of the LED modules 18 of the second embodiment. Each of the LED module arrays in two lines is the LED module array shown in FIG. 4C. Thus, similarly, in the LED modules which are adjacent to each other on the upper and lower sides (within a column) and the left and right sides (within a row), each first LED 18A and each second LED 18B are alternately arranged.

FIG. 6A shows an example of a circuit diagram of a light source device 16. In the array of the LED modules 18 in the first line, the first LEDs 18A are connected in series, and the second LEDs 18B are also connected in series. Similarly, in the array of the LED modules 18 in the second line, the first LEDs 18A are connected in series, and the second LEDs 18B are connected in series. In other words, the first LED 18A and the second LED 18B within one package are not electrically connected to each other. The cathode of the LED at an end of the series-connected array of the first LEDs 18A in each of the first and second lines, and the cathode of the LED at an end of the series-connected array of the second LEDs 18B in each of the first and second lines are both connected to the negative terminal of a direct-current power source 24 within a drive circuit 22. The anode of the LED at the other end of the series-connected array of the first LEDs 18A in each of the first and second lines, and the anode of the LED at the other end of the series-connected array of the second LEDs 18B in each of the first and second lines are both connected to a pulse width modulator 26 within the drive circuit 22 via a selector 30. The other structures are the same as FIG. 4A.

In this manner, according to the second embodiment, a backlight comprising an LED module array provided in a plurality of lines can be realized. Further, by inverting the placement order of the first LED and the second LED in each LED module in the first and second lines (the first LED, the second LED in the first line, and the second LED, the first LED in the second line), it is possible to emit light which is uniform in a two-dimensional manner.

The various modules of the systems described herein can be implemented as software applications, hardware and/or software modules, or components on one or more computers, such as servers. While the various modules are illustrated separately, they may share some or all of the same underlying logic or code.

For example, in the above-described embodiments, the LED light source is formed by arranging a plurality of LED modules including a plurality of LEDs which differ in the current and luminance characteristics in a line on the substrate. However, it is not always necessary to arrange LED modules comprising a plurality of LEDs which differ in the current and luminance characteristics within one package. The first and second LEDs may be alternately arranged directly on the substrate as shown in the circuit diagrams of FIG. 4A and FIG. 6A. The examples in which a plurality of LED modules are dispersed on the substrate as shown in FIG. 4B and FIG. 6B are explained. However, the plurality of LED modules may be arranged so as to be adjacent to each other without intervals. Further, the number of LED types is not limited to two. Three types or more than three types of LEDs may be used, and the LED type may be selected based on three or more than three setting luminance ranges.

The edge light type of backlight is explained. However, the embodiments can be also applied to the direct type of backlight. In portable devices such as PCs and tablets, since there is demand for a thin type, the edge light type of backlight is used in many cases. In portable devices, there is a case where the surrounding brightness is detected by a sensor to change the luminance of the display panel depending on the brightness. When the surrounding area is bright, the user may want to have the screen luminous with higher luminance, and when the surrounding area is dark or the battery is driven, the user may want to have the screen dark with lower luminance. In these cases, the above embodiments are effective. The direct type of backlight is sometimes used for TVs. However, the luminance of TVs is rarely reduced in use.

The selector 30 exclusively selects the LED array of the first characteristics and the LED array of the second characteristics. However, in the switching period, the arrays can be selected based on weighting. For example, the state in which 100% of drive signals flows in the LED array of the first characteristics may be changed to the state in which 90% of drive signals flows in the LED array of the first characteristics and 10% of drive signals flows in the LED array of the second characteristics. In this manner, the proportion of drive signals flowing in the LED arrays of the first and second characteristics may be gradually changed. Ultimately, the state may be changed to the state in which 0% of drive signals flows in the LED array of the first characteristics and 100% of drive signals flows in the LED array of the second characteristics.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

Each of the functions of the described embodiments may be implemented by one or more processing circuits. A processing circuit includes a programmed processor, as a processor includes circuitry. A processing circuit also includes devices such as an application specific integrated circuit (ASIC) and conventional circuit components arranged to perform the recited functions.

What is claimed is:

1. A light-emitting module comprising:
a first light-emitting element in which a luminance for a first current is within a first range including a first luminance; and
a second light-emitting element in which a luminance for the first current is within a third range, and a luminance for a second current which is higher than the first current is within a second range including a second luminance which is higher than the first luminance, and a luminance of the third range is higher than a luminance of the first range, wherein
the first light-emitting element and the second light-emitting element are within one package.

2. The light-emitting module of claim 1, wherein
the first light-emitting element and the second light-emitting element comprise a light-emitting diode.

3. The light-emitting module of claim 2, wherein
a value of the first range is equal to a value of the second range.

4. The light-emitting module of claim 3, wherein
a luminance of the first light-emitting element for the second current is within the third range including the second range.

5. A light source device comprising:
a plurality of first light-emitting elements; and
a plurality of second light-emitting elements, wherein
the plurality of first light-emitting elements and the plurality of second light-emitting elements are alternately arranged in a line,
a luminance of each of the plurality of first light-emitting elements for a first current is within a first range including a first luminance, and
a luminance of each of the plurality of second light-emitting elements for a second current which is higher than the first current is within a second range including a second luminance which is higher than the first luminance.

6. The light source device of claim 5, wherein
the plurality of first light-emitting elements and the plurality of second light-emitting elements comprise a light-emitting diode.

7. The light source device of claim 6, wherein
a value of the first range is equal to a value of the second range.

8. The light source device of claim 7, wherein
luminance of the first light-emitting elements for the second current is within a third range including the second range.

9. The light source device of claim 8, wherein
luminance of the second light-emitting elements for the first current is within a fourth range including the first range.

10. The light source device of claim 5, wherein
the plurality of first light-emitting elements and the plurality of second light-emitting elements are alternately arranged in a plurality of lines on a column direction and a row direction.

11. The light source device of claim 5, wherein
the plurality of first light-emitting elements and the plurality of second light-emitting elements are within one package one by one.

12. A light source device comprising:
a first light-emitting module comprising a first light-emitting element of a first characteristic and a second light-emitting element of a second characteristic within a first package;
a second light-emitting module comprising a third light-emitting element of the first characteristic and a fourth light-emitting element of the second characteristic within a second package; and
a drive unit to selectively drive a group of the first light-emitting element and the third light-emitting element or a group of the second light-emitting element and the fourth light-emitting element.

13. The light source device of claim 12, wherein
the first light-emitting element and the third light-emitting element emit light with a luminance within a first range including a first luminance for a first current,
the second light-emitting element and the fourth light-emitting element emit light with a luminance within a second range including a second luminance which is higher than the first luminance for a second current which is higher than the first current, and
the drive unit drives the first light-emitting element and the third light-emitting element when a luminance setting value of the light source device is within the first range, and drives the second light-emitting element and the fourth light-emitting element when the luminance setting value is within the second range.

14. The light source device of claim 13, wherein
the first light-emitting element, the second light-emitting element, the third light-emitting element and the fourth light-emitting element comprise a light-emitting diode.

15. The light source device of claim 14, wherein
a value of the first range is equal to a value of the second range.

16. The light source device of claim 15, wherein
luminance of the first light-emitting element and the third light-emitting element for the second current is within a third range including the second range.

17. The light source device of claim 16, wherein
luminance of the second light-emitting element and the fourth light-emitting element for the first current is within a fourth range including the first range.

18. The light source device of claim 12, wherein
the first light-emitting module and the second light-emitting module are arranged such that the second light-emitting element is adjacent to the third light-emitting element.

19. The light source device of claim 10, further comprising:
a third light-emitting module comprising a fifth light-emitting element of the first characteristic and a sixth light-emitting element of the second characteristic within a third package; and
a fourth light-emitting module comprising a seventh light-emitting element of the first characteristic and an eighth light-emitting element of the second characteristic within a fourth package, wherein
the first light-emitting module and the second light-emitting module are arranged such that the second light-emitting element is adjacent to the third light-emitting element,
the third light-emitting module and the fourth light-emitting module are arranged such that the fifth light-emitting element is adjacent to the eighth light-emitting element,
the first light-emitting module and the third light-emitting module are arranged such that the first light-emitting element is adjacent to the sixth light-emitting element, and
the drive unit selectively drives a group of the first light-emitting element, the third light-emitting element, the fifth light-emitting element and the seventh light-emitting element or a group of the second light-emitting element, the fourth light-emitting element, the sixth light-emitting element and the eighth light-emitting element.
